(19) United States
(12) Patent Application Publication
(10) Pub. No.: US 2023/0342152 A1
(43) Pub. Date: Oct. 26, 2023

(54) PARALLEL PROCESSING ARCHITECTURE WITH SPLIT CONTROL WORD CACHES

(71) Applicant: Ascenium, Inc., Campbell, CA (US)

(72) Inventor: Peter Foley, Los Altos Hills, CA (US)

(73) Assignee: Ascenium, Inc., Campbell, CA (US)

(21) Appl. No.: 18/215,866

(22) Filed: Jun. 29, 2023

Related U.S. Application Data
(63) Continuation-in-part of application No. 17/526,003, filed on Nov. 15, 2021.
Application No. 17/526,003 is a continuation-in-part of application No. 17/465,949, filed on Sep. 3, 2021.
(60) Provisional application No. 63/460,909, filed on Apr. 21, 2023.
(60) Provisional application No. 63/447,915, filed on Feb. 24, 2023.
(60) Provisional application No. 63/442,131, filed on Jan. 31, 2023.
(60) Provisional application No. 63/424,960, filed on Nov. 14, 2022.
(60) Provisional application No. 63/424,961, filed on Nov. 14, 2022.
(60) Provisional application No. 63/402,490, filed on Aug. 31, 2022.
(60) Provisional application No. 63/400,087, filed on Aug. 23, 2022.
(60) Provisional application No. 63/393,989, filed on Aug. 1, 2022.
(60) Provisional application No. 63/388,268, filed on Jul. 12, 2022.
(60) Provisional application No. 63/357,030, filed on Jun. 30, 2022.
(60) Provisional application No. 63/254,557, filed on Oct. 12, 2021.
(60) Provisional application No. 63/232,230, filed on Aug. 12, 2021.
(60) Provisional application No. 63/229,466, filed on Aug. 4, 2021.
(60) Provisional application No. 63/193,522, filed on May 26, 2021.
(60) Provisional application No. 63/166,298, filed on Mar. 26, 2021.
(60) Provisional application No. 63/125,994, filed on Dec. 16, 2020.
(60) Provisional application No. 63/114,003, filed on Nov. 16, 2020.
(60) Provisional application No. 63/091,947, filed on Oct. 15, 2020.
(60) Provisional application No. 63/075,849, filed on Sep. 9, 2020.

(51) Int. Cl. G06F 9/30; G06F 9/38

(52) U.S. Cl. CPC G06F 9/30145; G06F 9/3814; G06F 9/3851

(57) ABSTRACT

Techniques for a parallel processing architecture with split control word caches are disclosed. A two-dimensional array of compute elements is accessed. Each compute element is known to a compiler and is coupled to its neighboring compute elements. A first control word cache is coupled to the array. The first control word cache enables loading control words to a first array portion. A second control word cache is coupled to the array. The second control word cache enables loading control words to a second array portion. The control words are split between the first and the second control word caches. The splitting is based on the constituency of the first and the second array portions. Instructions are executed within the array. Instructions executed within the first array portion use control words loaded from the first cache. Instructions executed within the second array portion use control words loaded from the second cache.

### RELATED APPLICATIONS

This application claims the benefit of U.S. provisional patent applications “Parallel Processing Architecture With Split Control Word Caches” Ser. No. 63/357,030, filed Jun. 30, 2022, “Parallel Processing Architecture With Countdown Tagging” Ser. No. 63/388,268, filed Jul. 12, 2022, “Parallel Processing Architecture With Dual Load Buffers” Ser. No. 63/393,989, filed Aug. 1, 2022, “Parallel Processing Architecture With Bin Packing” Ser. No. 63/400,087, filed Aug. 23, 2022, “Parallel Processing Architecture With Memory Block Transfers” Ser. No. 63/402,490, filed Aug. 31, 2022, “Parallel Processing Using Hazard Detection And Mitigation” Ser. No. 63/424,960, filed Nov. 14, 2022, “Parallel Processing With Switch Block Execution” Ser. No. 63/424,961, filed Nov. 14, 2022, “Parallel Processing With Hazard Detection And Store Probes” Ser. No. 63/442,131, filed Jan. 31, 2023, “Parallel Processing Architecture For Branch Path Suppression” Ser. No. 63/447,915, filed Feb. 24, 2023, and “Parallel Processing Hazard Mitigation Avoidance” Ser. No. 63/460,909, filed Apr. 21, 2023.

This application is also a continuation-in-part of U.S. patent application “Highly Parallel Processing Architecture With Compiler” Ser. No. 17/526,003, filed Nov. 15, 2021, which claims the benefit of U.S. provisional patent applications “Highly Parallel Processing Architecture With Compiler” Ser. No. 63/114,003, filed Nov. 16, 2020, “Highly Parallel Processing Architecture Using Dual Branch Execution” Ser. No. 63/125,994, filed Dec. 16, 2020, “Parallel Processing Architecture Using Speculative Encoding” Ser. No. 63/166,298, filed Mar. 26, 2021, “Distributed Renaming Within A Statically Scheduled Array” Ser. No. 63/193,522, filed May 26, 2021, “Parallel Processing Architecture For Atomic Operations” Ser. No. 63/229,466, filed Aug. 4, 2021, “Parallel Processing Architecture With Distributed Register Files” Ser. No. 63/232,230, filed Aug. 12, 2021, and “Load Latency Amelioration Using Bunch Buffers” Ser. No. 63/254,557, filed Oct. 12, 2021.

The U.S. patent application “Highly Parallel Processing Architecture With Compiler” Ser. No. 17/526,003, filed Nov. 15, 2021 is also a continuation-in-part of U.S. patent application “Highly Parallel Processing Architecture With Shallow Pipeline” Ser. No. 17/465,949, filed Sep. 3, 2021, which claims the benefit of U.S. provisional patent applications “Highly Parallel Processing Architecture With Shallow Pipeline” Ser. No. 63/075,849, filed Sep. 9, 2020, “Parallel Processing Architecture With Background Loads” Ser. No. 63/091,947, filed Oct. 15, 2020, “Highly Parallel Processing Architecture With Compiler” Ser. No. 63/114,003, filed Nov. 16, 2020, “Highly Parallel Processing Architecture Using Dual Branch Execution” Ser. No. 63/125,994, filed Dec. 16, 2020, “Parallel Processing Architecture Using Speculative Encoding” Ser. No. 63/166,298, filed Mar. 26, 2021, “Distributed Renaming Within A Statically Scheduled Array” Ser. No. 63/193,522, filed May 26, 2021, Parallel Processing Architecture For Atomic Operations” Ser. No. 63/229,466, filed Aug. 4, 2021, and “Parallel Processing Architecture With Distributed Register Files” Ser. No. 63/232,230, filed Aug. 12, 2021.

Each of the foregoing applications is hereby incorporated by reference in its entirety.

### FIELD OF ART

This application relates generally to parallel processing and more particularly to a parallel processing architecture with split control word caches.

### BACKGROUND

In our modern societies, digital computing systems touch nearly every facet of work, rest, and play. Many businesses, governments, social groups, and individuals rely upon digital communications, computer analyses, graphics, animation, personal computers, cell phones, social media platforms, and streaming video sites on a daily, if not hourly, basis. Industries and activities that were once completely devoid of computing systems are now inundated with computer chips, digital sensors, infrared monitors, satellite links, Bluetooth connections, and cellular network links. We can use digital platforms to turn on lights, adjust the temperature in our vehicles, find a song or video we might like, join conferences, write or edit a paper, generate illustrations and graphics, monitor air traffic, and select the best route to work. Digital technologies have become so pervasive that some in our younger generations are unaware of how to use earlier modes of navigation, research, or communications, just as older generations became ignorant of semaphore flags or using a sextant.

All of these modern technologies require not only electronic computing systems and sophisticated programming, but perhaps most importantly, data. Copious amounts of data. Chat systems rely on millions of pages of text to be consumed by AI learning systems in order to simulate human language. Financial systems manage billions of transactions on a daily basis and communicate with other financial systems over secured networks. Military systems gather data from satellites, listening posts, weather stations, human observers, and other sources to report on current conditions and predict possible threats. Marketing and advertising groups rely on trillions of data points collected on millions of shoppers. And the list goes on. As with many endeavors, it is generally much easier to collect data than it is to process it. As computing systems have evolved and matured, our ability to store data on ever-expanding database platforms has grown exponentially. Database platforms linked across cities, states, and countries hold many petabytes of data on many different subjects. And our collection systems continue to grow. We collect data on everything, even when our ability to analyze and report on the data, and to locate trends and create useful collations of the information, may take weeks or months to complete. For example, some elements of the 2020 U.S. Census will not be completed until 2025. Data elements can be simple or complicated, short as a byte or many digits long, static or variable. In order to handle such disparate types of information, storage systems have become more and more complex as the amounts of storage being amassed to be summarized or analyzed has grown. It is estimated that the amount of data held in computer storage systems at the beginning of 2020 was 44 zettabytes. A zettabyte is 10 to the 21^{st} power, written out as a 1 with 21 zeros behind it. By 2025, this number will have grown to 175 zettabytes of data, much of it stored and used by multinational corporations and governments.

Our hunger for more data continues to grow, in many cases beyond our ability to process it in a reasonable timeframe. Even so, we continue to collect data, store it, guard it zealously, and value it highly. As the volume of data grows, computer scientists, researchers, programmers, engineers, and designers will continue to search for innovative ways to process the data in more efficient ways in order to bring the right analyses to bear. The rapid and effective processing of large amounts of data is vital to the success of every organization that wishes to survive in the modern world.

### SUMMARY

Datasets of vast dimensions are processed in support of the goals, objections, and missions of organizations large and small. The processing of the data is based on issuing processing “jobs” that load, manipulate, store, and maintain data. The complexity of the processing jobs varies widely. Further, any one of the processing jobs can be considered mission critical for the organization. The execution of the processing jobs is therefore essential to the organizations. The job mix often varies widely. Among the most processed jobs are running payroll, billing, analyzing research data, registering grades, and training a neural network for machine learning, among many others. These processing jobs are often highly complex and are based on the successful execution of many individual tasks. The processing tasks can include loading and storing datasets, accessing processing components and systems, executing data processing operations, etc. The tasks are typically assembled from subtasks which themselves can be complex. The subtasks can often be used to handle specific computational jobs such as loading data from storage; performing arithmetic computations, logic evaluations, and other data manipulation tasks; storing the data back to storage; handling inter-subtask communication such as input and output data transfer and control; and so on. The datasets that are accessed are often vast in size and complexity. Processing of the datasets can easily overwhelm traditional processing architectures. Processing architectures, such as Von Neumann class configurations that are either poorly matched to the processing tasks or inflexible in their designs, simply cannot manage the data handing and computation tasks. The architectures become saturated, thereby limiting the amount of data that can be processed in allowable time.

Substantial efficiency and throughput improvements to task processing are accomplished with configurable two-dimensional (2D) arrays of elements. The 2D arrays of elements can be configured and employed for the processing of the tasks and subtasks. The 2D arrays include compute elements, multicycle elements, registers, caches, queues, register files, buffers, controllers, decompressors, arithmetic logic units (ALUs), storage elements, and other components. Communication elements enable communication among the various elements. These arrays of elements are configured and operated by providing control to the array of elements on a cycle-by-cycle basis. The control of the 2D array is enabled by a stream of wide control words. The control words can include wide control words generated by the compiler. The control can include precedence information. The precedence information can be used by hardware to derive a precedence value, where the precedence information comprises a template value supplied by the compiler. The template value can include a seed value. The precedence value enables hardware ordering of the load and store operations performed by multiple, independent loops. The ordering of loads and stores can be used to identify load hazards and store hazards. The hazards can be avoided by delaying the promotion of data to a store buffer.

In addition to the various components that can be associated with the 2D array of compute elements, an associative memory can be included in each compute element. A grouping of two or more compute elements can be established within a portion of the array of compute elements. The groupings can include pairs, quads, segments, quadrants, etc. of the 2D array. The groups can be associated with the split control word caches. The established groupings can include a topological set of compute elements, where a topological set of compute elements can include a circuit topology such as a systolic, a vector, a cyclic, a streaming, or a Very Long Instruction Word (VLIW) topology, among others. The topologies can include a topology that enables machine learning functionality. The customization of one or more control word templates can be enabled by the associative memory. The associative memory provides a match between a control word tag, which can include a three-bit tag and a compute element operation.

Parallel processing using compute elements is accomplished based on a parallel processing architecture with split control word caches. A two-dimensional (2D) array of compute elements is accessed, wherein each compute element within the array of compute elements is known to a compiler and is coupled to its neighboring compute elements within the array of compute elements. A first control word cache is coupled to the array of compute elements, wherein the first control word cache enables loading control words to a first portion of the array of compute elements. A second control word cache is coupled to the array of compute elements, wherein the second control word cache enables loading control words to a second portion of the array of compute elements. The control words are split between the first control word cache and the second control word cache, wherein the splitting is based on the constituency of the first portion of the array of compute elements and the second portion of the array of compute elements. Instructions are executed within the array of compute elements, wherein instructions executed within the first portion of the array of compute elements use control words loaded from the first control word cache, and wherein instructions executed within the second portion of the array of compute elements use control words loaded from the second control word cache.

A processor-implemented method for parallel processing is disclosed comprising: accessing a two-dimensional array of compute elements, wherein each compute element within the array of compute elements is known to a compiler and is coupled to its neighboring compute elements within the array of compute elements; coupling a first control word cache to the array of compute elements, wherein the first control word cache enables loading control words to a first portion of the array of compute elements; coupling a second control word cache to the array of compute elements, wherein the second control word cache enables loading control words to a second portion of the array of compute elements; splitting the control words between the first control word cache and the second control word cache, wherein the splitting is based on constituency of the first portion of the array of compute elements and the second portion of the array of compute elements; and executing instructions within the array of compute elements, wherein instructions executed within the first portion of the array of compute elements use control words loaded from the first control word cache, and wherein instructions executed within the second portion of the array of compute elements use control words loaded from the second control word cache. Some embodiments comprise coupling a first control unit between the first control word cache and the first portion of the array of compute elements. Some embodiments comprise coupling a second control unit between the second control word cache and the second portion of the array of compute elements. In embodiments, the first control unit distributes control word information to the first portion of the array of compute elements. And in embodiments, the second control unit distributes control word information to the second portion of the array of compute elements.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for a parallel processing architecture with split control word caches.

FIG. 2 is a flow diagram for control unit operation.

FIG. 3 is a system block diagram for compressed control word (CCW) splitting.

FIG. 4 is a system block diagram for a highly parallel architecture with a shallow pipeline.

FIG. 5 shows compute element array detail with a split CCW.

FIG. 6 illustrates a system block diagram for compiler interactions.

FIG. 7 is a system diagram for a parallel processing architecture with split control word caches.

### DETAILED DESCRIPTION

Techniques for a parallel processing architecture with split control word caches are disclosed. In a processing architecture such as an architecture based on configurable compute elements as described herein, a stall condition can occur while loading control words, compute element operations, compute element operation priorities or precedence, and so on. Similarly, the loading and storing of data can cause execution of a process, task, subtask, and the like to stall. For example, load data arriving late to the array due to bus contention, memory access time delays, etc., can require the stalling of the entire two-dimensional (2D) array of compute elements in order to maintain architectural cycle coherency and integrity of the statically scheduled process. Noted throughout, control for the array of compute elements is provided on a cycle-by-cycle basis. The control of the 2D array is enabled by a stream of wide control words. The control words can include wide, variable length, microcode control words generated by the compiler. The control words can comprise compute element operations. The control words can be variable length, as described by the architecture, or they can be fixed length. However, a fixed length control word can be compressed, which can result in variable lengths for operational usage to save space. The control words can be split between a first control word cache and a second control word cache. The splitting of the control words enables control of portions of the array of compute elements. The portions of the array can be operated in lockstep, yet independently, on a cycle-by-cycle basis.

The compiler can further provide precedence information that can be used by the memory system supporting the array of compute elements to order load operations and store operations. The ordering based on the precedence information can include hints, such as a numerical sequence, that enables the memory system to perform loads and stores while maintaining data integrity. The ordering can be based on identifying load hazards and store hazards, generally known as memory hazards, where a hazard can include storing data over valid data, reading invalid data, and so on. The hazards can include write-after-read, read-after-write, write-after-write, and similar conflicts. The hazards can be avoided based on a comparative precedence value. The hazards can be avoided by holding the loads and stores in an access buffer “in front” of memory (between data caches and a crossbar switch, described subsequently), and load and/or store delays are managed in terms of when the loads and stores are allowed to proceed to and/or from memory (in some cases, store data can be immediately returned as load data, such as for store-to-load forwarding). A key function of the crossbar is to spatially localize accesses that may conflict so that the (re)ordering can occur. The compute elements within the 2D array of compute elements can be configured to perform parallel processing of multiple, independent loops. Each loop can include a set of compute element operations, and the set of compute element operations can be executed a number of times (i.e., iteration). Groupings of compute elements can be established within the array of compute elements, and the multiple, independent loops can be assigned to the established groupings.

The specific set of compute element operations that comprises a process, task, subtask, etc. can be loaded into one or more caches, storage elements, registers, etc. In embodiments, control words are split between a first cache and a second cache. Each cache can hold control words that are used to control a portion of the array of compute elements. An additional small memory, called a bunch buffer, can be included in a compute element. A bunch is that group of bits in a control word that controls a single compute element. Essentially, each bunch buffer will contain the bits (i.e., “bunches”) that would otherwise be driven into the array to control a given compute element. In addition, a compute element may include its own small “program counter” to index into the bunch buffer and may also have the ability to take a “micro-branch” within that compute element.

The control word caches can comprise register files; small, fast memories; and so on. The caches can be formed from one read port and write port (1R1W) registers. Alternatively, the registers can be based on a memory element with two read ports, and one write port (2R1W). The 2R1W memory element enables two read operations and one write operation to occur substantially simultaneously. An associative memory can be included in each compute element of the topological set of compute elements. The associative memory can be based on a 2R1W register, where the 2R1W register can be distributed throughout the array. The control words that are stored in the caches can be compressed in order to save storage space, to reduce transfer time, and so on. The compressed control words can be decompressed in order to access the compute element operations associated with each compressed control word. The compute element operations associated with the decompressed control words can be written to an associative memory associated with each compute element within the 2D array of compute elements. The specific sets of instructions can configure the compute elements, enable the compute elements to execute operations within the array, and so on. The compute element groupings can include a topological set of compute elements from the 2D array of compute elements. The topological set of compute elements can be configured by control words provided by the compiler. The configuring the compute elements can include placement and routing information for the compute elements and other elements within the 2D array of compute elements. The specific set of compute element operations associated with the control words stored in the caches can include a number of operations that can accomplish some or all of the operations associated with a task, a subtask, and so on. By providing a sufficient number of operations, autonomous operation of the compute element can be accomplished. The autonomous operation of the compute element can be based on operational looping, where the operational looping is enabled without additional control word template loading. The looping can be enabled based on ordering load operations and store operations such that memory access hazards are avoided. Recall that latency associated with access by a compute element to storage can be significant and can cause the compute element to stall. By performing operations within a compute element grouping, latency can be eliminated, thus expediting the execution of operations.

Tasks and subtasks that are executed by the compute elements within the array of compute elements can be associated with a wide range of applications. The applications can be based on data manipulation, such as image or audio processing applications, facial recognition, voice recognition, AI applications based on neural networks, business applications, data processing and analysis, and so on. The tasks that are executed can perform a variety of operations including arithmetic operations, shift or rotate operations, logical operations including Boolean operations, vector or matrix operations, tensor operations, and the like. The subtasks can be executed based on precedence, priority, coding order, amount of parallelization, data flow, data availability, compute element availability, communication channel availability, and so on.

The data manipulations are performed on a two-dimensional (2D) array of compute elements (CEs). The compute elements within the 2D array can be implemented with central processing units (CPUs), graphics processing units (GPUs), application specific integrated circuits (ASICs), field programmable gate arrays (FPGAs), processing cores, or other processing components or combinations of processing components. The compute elements can include heterogeneous processors, homogeneous processors, processor cores within an integrated circuit or chip, etc. The compute elements can be coupled to local storage, which can include local memory elements, register files, cache storage, associative memories, etc. The cache, which can include a hierarchical cache such as an “L1”, “L2”, and “L3” cache, can be used for storing data such as intermediate results, compressed control words, coalesced control words, decompressed control words, relevant portions of a control word, and the like. The cache can store data produced by a taken branch path, where the taken branch path is determined by a branch decision. The decompressed control word is used to control one or more compute elements within the array of compute elements. Multiple layers of the two-dimensional (2D) array of compute elements can be “stacked” to comprise a three-dimensional array of compute elements.

The tasks, subtasks, etc., that are associated with processing operations are generated by a compiler. The compiler can include a general-purpose compiler, a hardware description-based compiler, a compiler written or “tuned” for the array of compute elements, a constraint-based compiler, a satisfiability-based compiler (SAT solver), a constraint-based and satisfiability-based compiler, and so on. Control is provided to the hardware in the form of control words, where one or more control words are generated by the compiler. The control words are split between a first control word cache and a second control word cache, where the splitting is based on a constituency of the first control word cache and a constituency of the second control word cache. The constituencies of the caches are associated with portions of the array of compute elements. One possible constituency can occur when the left half of the array of compute elements is controlled by the first control word, and the right half of the array of compute elements is controlled by the second control word. Other constituencies are possible. The control words are provided to the array on a cycle-by-cycle basis. The control words can include wide, variable length, microcode control words. The length of a microcode control word can be adjusted by compressing the control word. The compressing can be accomplished by recognizing situations where a compute element is unneeded by a task. Thus, control bits within the control word associated with the unneeded compute elements are not required for that compute element. Other compression techniques can also be applied. The control words can be used to route data, to set up operations to be performed by the compute elements, to idle individual compute elements or rows and/or columns of compute elements, etc. Noting that the compiled microcode control words that are generated by the compiler are based on bits, the control words can be compressed by selecting bits from the control words. The control of the compute elements can be accomplished by a control unit.

Parallel processing is enabled by a parallel processing architecture with split control word caches. The parallel processing can include data manipulation by multiple independent loops. A two-dimensional (2D) array of compute elements is accessed. The compute elements can include compute elements, processors, or cores within an integrated circuit; processors or cores within an application specific integrated circuit (ASIC); cores programmed within a programmable device such as a field programmable gate array (FPGA), and so on. The compute elements can include homogeneous or heterogeneous processors. Each compute element within the 2D array of compute elements is known to a compiler. The compiler, which can include a general-purpose compiler, a hardware-oriented compiler, or a compiler specific to the compute elements, can compile code for each of the compute elements. Each compute element is coupled to its neighboring compute elements within the array of compute elements. The coupling of the compute elements enables data communication between and among compute elements. A first control word cache is coupled to the array of compute elements. The control word cache can be based on a register file; small, fast storage; and the like. The first control word cache enables loading control words to a first portion of the array of compute elements. The portion of the array of compute elements can include individual compute elements, pairs or quads of elements, groupings of elements, quadrants of the array, etc. A second control word cache is coupled to the array of compute elements. The second control word cache enables loading control words to a second portion of the array of compute elements. Control for the compute elements can be provided on a cycle-by-cycle basis. Control is enabled by a stream of wide control words generated by the compiler. In embodiments, the array of compute elements is controlled on a cycle-by-cycle basis by a stream of wide control words generated by the compiler. In embodiments, the stream of wide control words comprises variable length control words generated by the compiler. In embodiments, the stream of wide control words generated by the compiler provides direct, fine-grained control of the 2D array of compute elements.

The cycle can include a clock cycle, a data cycle, a processing cycle, a physical cycle, an architectural cycle, etc. The control word lengths can vary based on the type of control, compression, simplification such as identifying that a compute element is unneeded, etc. The control words are split between the first control word cache and the second control word cache. The splitting is based on the constituency of the first portion of the array of compute elements and the second portion of the array of compute elements. The splitting can be based on processes, tasks, subtasks, etc. The control words within the control word caches, which can include compressed control words, can be decoded and provided to a control unit. A control unit can be associated with each control word cache. The one or more control units control the array of compute elements in their respective portions of the array of compute elements. The control word can be decompressed to a level of fine control granularity, where each compute element (whether an integer compute element, floating point compute element, address generation compute element, write buffer element, read buffer element, etc.), is individually and uniquely controlled. A compressed control word can be decompressed to allow control on a per element basis. The decoding can be dependent on whether a given compute element is needed for processing a task or subtask; whether the compute element has a specific control word associated with it or the compute element receives a repeated control word (e.g., a control word is used for two or more compute elements), and the like.

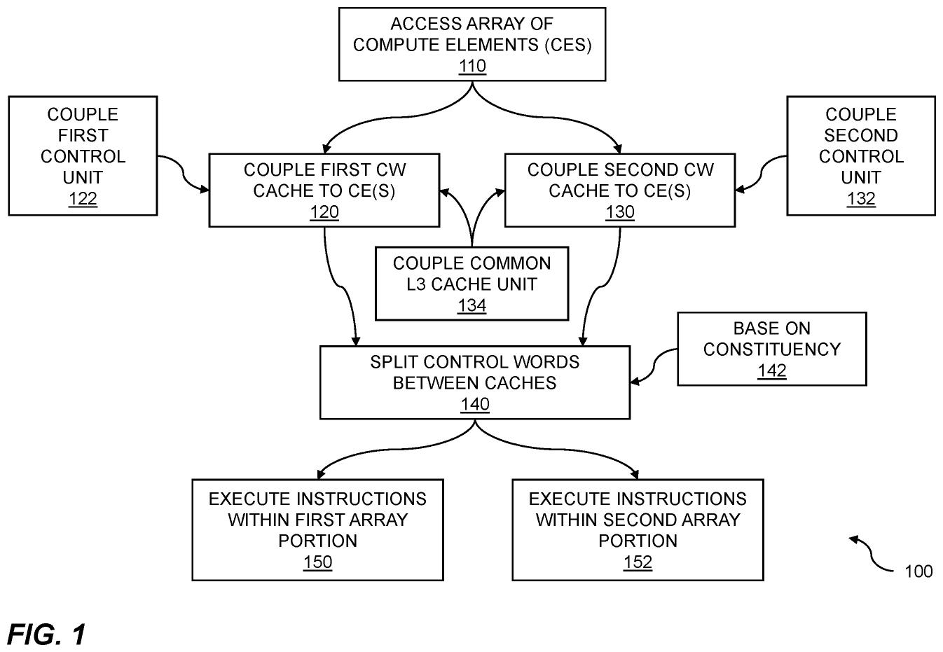

FIG. 1 is a flow diagram for a parallel processing architecture with split control word caches. Groupings of compute elements (CEs), such as CEs assembled within a 2D array of CEs, can be configured to execute a variety of operations associated with data processing. The operations can be based on tasks and on subtasks, where the subtasks are associated with the tasks. The tasks and subtasks that can be associated with multiple, independent loops include load operations and store operations. The 2D array can further interface with other elements such as controllers, storage elements, ALUs, memory management units (MMUs), graphics processing units (GPUs), multiplier elements, and so on. The loop operations can accomplish a variety of processing objectives such as application processing, data manipulation, data analysis, and so on. The operations can manipulate a variety of data types including integer, real, and character data types; vectors and matrices; tensors; etc. In embodiments, the compute element operations can include arithmetic logic unit (ALU) operations. Each compute element within the array of compute elements is known to a compiler and is coupled to its neighboring compute elements within the array of compute elements. Control for the compute elements is provided on a cycle-by-cycle basis. The control is enabled by a stream of wide control words generated by the compiler. The variable length control words generated by the compiler can be compressed control words (CCWs), which are converted on a cycle-by-cycle basis at run-time into fixed length control words (CWs) by the hardware and then driven into the array. The control words, which can include microcode control words, enable or idle various compute elements; provide data; route results between or among CEs, caches, and storage; and the like. The control enables compute element operation, memory access precedence, etc. Compute element operation and memory access precedence enable the hardware to properly sequence data provision and compute element results. The control enables execution of a compiled program on the array of compute elements.

The flow 100 includes accessing a two-dimensional (2D) array 110 of compute elements, wherein each compute element within the array of compute elements is known to a compiler and is coupled to its neighboring compute elements within the array of compute elements. The compute elements within the 2D array can be based on a variety of types of computers, processors, and so on. The compute elements or CEs can include central processing units (CPUs), graphics processing units (GPUs), processors or processing cores within application specific integrated circuits (ASICs), processing cores programmed within field programmable gate arrays (FPGAs), and so on. In embodiments, compute elements within the array of compute elements have identical functionality. The compute elements can include heterogeneous compute resources, where the heterogeneous compute resources may or may not be collocated within a single integrated circuit or chip. The compute elements can be configured in a topology, where the topology can be built into the array, programmed or configured within the array, etc. In embodiments, the array of compute elements is configured by a control word (discussed below) to implement one or more of a systolic, a vector, a cyclic, a spatial, a streaming, or a Very Long Instruction Word (VLIW) topology.

The compute elements can further include a topology suited to machine learning computation. The compute elements can be coupled to other elements within the array of CEs. In embodiments, the coupling of the compute elements can enable one or more topologies. The other elements to which the CEs can be coupled can include storage elements such as one or more levels of cache storage; multiplier units; address generator units for generating load (LD) and store (ST) addresses; queues; and so on. The compiler to which each compute element is known can include a C, C++, or Python compiler. The compiler to which each compute element is known can include a hardware description language (HDL) compiler, a compiler written especially for the array of compute elements, etc. The coupling of each CE to its neighboring CEs enables sharing of elements such as cache elements, multiplier elements, ALU elements, or control elements; communication between or among neighboring CEs; and the like.

The flow 100 includes coupling 120 a first control word cache to the array of compute elements, wherein the first control word cache enables loading control words to a first portion of the array of compute elements. The first control word cache can include fast, local storage. The first control word cache can include one or more levels of caches. In embodiments, the first control word cache comprises a level-1/level-2 (L1/L2) cache bank. The control words include the control words generated by the compiler. In embodiments, the first control word cache stores compressed control words. The first control word cache can further store uncompressed control words, decompressed control words, etc. Discussed previously, the control words can include variable-length control words. In embodiments, the compressed control words can be decompressed before being consumed by a next unit. The next unit can include a controller. The flow 100 further includes coupling a first control unit 122 between the first control word cache and the first portion of the array of compute elements. The first control unit can be used to configure compute elements, to enable data access for loading and storing, and so on. In embodiments, the first control unit can distribute control word information to the first portion of the array of compute elements. The control word information can be used to enable or idle one or more of individual compute elements, rows of compute elements, columns of compute elements, and the like.

The flow 100 further includes coupling 130 a second control word cache to the array of compute elements, wherein the second control word cache enables loading control words to a second portion of the array of compute elements. The second control word cache can be substantially similar to or substantially different from the first control word cache. The second control word cache can include fast, local storage and can comprise one or more levels of caches. In embodiments, the second control word cache comprises a level-1/level-2 (L1/L2) cache bank. The control words stored within the second control word cache include control words generated by the compiler. In embodiments, the second control word cache stores compressed control words. Other control word formats, including uncompressed control words, decompressed control words, etc., can be stored. Discussed previously and throughout, the control words can include variable-length control words. In embodiments, the compressed control words can be decompressed before being consumed by a next unit. The next unit can include a controller. The flow 100 further includes coupling a second control unit 132 between the second control word cache and the second portion of the array of compute elements. The second control unit can be used substantially similarly to the first control unit to configure compute elements, enable data access for loading and storing, etc. In embodiments, the second control unit can distribute control word information to the second portion of the array of compute elements. The control word information can be used to enable or idle one or more of individual compute elements, rows of compute elements, columns of compute elements, and so on.

The flow 100 further includes coupling a common level-3 (L3) cache 134 to the first control word cache and the second control word cache. The common L3 cache can be used to hold compressed control words that can be provided to the first control word cache and to the second control word cache. The common L3 cache can further be used to hold data for processing by the first portion and the second portion of compute elements within the compute element array. The L3 can be loaded prior to providing the compressed control words to the first control word cache and the second control word cache. The flow 100 includes splitting 140 the control words between the first control word cache and the second control word cache. The splitting control words between the first control word cache and the second control word cache can be based on one or more of processors, tasks, subtasks, and so on generated by the compiler. The splitting can be based on execution order of the processes, tasks, and subtasks. In a usage example, a graph such as a directed acyclic graph (DAG) or a Petri Net is compiled for execution on the 2D array of compute elements. Independent nodes within the graph, that is nodes that do not directly share data or control, can be split between the control word caches. Further, processes that can be executed in parallel, such as single instruction multiple data (SIMD) processes, can be split between the caches. The splitting can be based on capabilities of compute elements within the compute element array. In the flow 100, the splitting is based on the constituency 142 of the first portion of the array of compute elements and the second portion of the array of compute elements. A constituency can include one or more compute elements, where one or more of the compute elements can include hardware or software capabilities that can enable certain types of processes, tasks, or subtasks.

Discussed throughout, the control for the compute elements can be provided on a cycle-by-cycle basis. The control for the array can include configuration of elements such as compute elements within the array; loading and storing data; routing data to, from, and among compute elements; and so on. The control can be enabled by a stream of wide control words. The control words can configure the compute elements and other elements within the array; enable or disable individual compute elements, rows and/or columns of compute elements; load and store data; route data to, from, and among compute elements; and so on. The one or more control words are generated by the compiler. The compiler which generates the control words can include a general-purpose compiler such as a C, C++, or Python compiler; a hardware description language compiler such as a VHDL or Verilog compiler; a compiler written for the array of compute elements; and the like. The compiler can be used to map functionality to the array of compute elements. In embodiments, the compiler can map machine learning functionality to the array of compute elements. The machine learning can be based on a machine learning (ML) network, a deep learning (DL) network, a support vector machine (SVM), etc. In embodiments, the machine learning functionality can include a neural network (NN) implementation. A control word generated by the compiler can be used to configure one or more CEs, to enable data to flow to or from the CE, to configure the CE to perform an operation, and so on. Depending on the type and size of a task that is compiled to control the array of compute elements, one or more of the CEs can be controlled, while other CEs are unneeded by the particular task. A CE that is unneeded can be marked in the control word as unneeded. An unneeded CE requires no data, nor is control information required by it. In embodiments, the unneeded compute element can be controlled by a single bit. In other embodiments, a single bit can control an entire row of CEs by instructing hardware to generate idle signals for each CE in the row. The single bit can be set for “unneeded”, reset for “needed”, or set for a similar usage of the bit to indicate when a particular CE is unneeded by a task.

The control words that are stored within the first control word cache and the second control word cache can be decompressed. The control words can comprise one or more instructions, where the instructions can be executed by compute elements within the array of compute elements. The flow 100 includes executing instructions 150 within the array of compute elements, wherein instructions executed within the first portion of the array of compute elements use control words loaded from the first control word cache. The executing instructions can include configuring compute elements, loading data, processing data, storing data, generating control signals, and so on. The flow 100 further includes executing instructions 152 within the array of compute elements, wherein instructions executed within the second portion of the array of compute elements use control words loaded from the second control word cache. The executing the instructions within the first portion of the array and the second portion of the array can be performed using a variety of processing techniques. In embodiments, the first control unit and the second control unit can operate in lockstep on a cycle-by-cycle basis. The lockstep operation can be achieved, for example, by having the first and second control unit exchange synchronization handshake signals. The lockstep operation can be used to exchange data, control, and so on between the portions of the array of compute elements. The lockstep operation can be used to order operations such that load/store hazards can be avoided. In embodiments, the first control unit and the second control unit can operate independently from each other. Independent operation can accomplish processing of unrelated tasks and subtasks, separate processes, and so on, in disjointed sets of compute elements, for example, a left half and a right half of compute elements.

The control words that are generated by the compiler can include a conditionality. In embodiments, the control includes a branch. Code, which can include code associated with an application such as image processing, audio processing, and so on, can include conditions which can cause execution of a sequence of code to transfer to a different sequence of code. The conditionality can be based on evaluating an expression such as a Boolean or arithmetic expression. In embodiments, the conditionality can determine code jumps. The code jumps can include conditional jumps as just described, or unconditional jumps such as a jump to a halt, exit, or terminate instruction. The conditionality can be determined within the array of elements. In embodiments, the conditionality can be established by a control unit. In order to establish conditionality by the control unit, the control unit can operate on a control word provided to the control unit. In embodiments, the control unit can operate on decompressed control words. The control words can be a decompressed by a decompressor logic block that decompresses words from a compressed control word cache on their way to the array. In embodiments, the set of directions can include a spatial allocation of subtasks on one or more compute elements within the array of compute elements.

The operations that are performed by the compute elements within the array can include arithmetic operations, logical operations, matrix operations, tensor operations, and so on. The operations that are executed are contained in the control words. Discussed above, the control words can include a stream of wide control words generated by the compiler. The control words can be used to control the array of compute elements on a cycle-by-cycle basis. A cycle can include a local clock cycle, a self-timed cycle, a system cycle, and the like. In embodiments, the executing occurs on an architectural cycle basis. An architectural cycle can include a read-modify-write cycle. In embodiments, the architectural cycle basis reflects non-wall clock, compiler time. The execution can include distributed execution of operations. In embodiments, the distributed execution of operations can occur in two or more compute elements within the array of compute elements, within a grouping of compute elements, and so on. The compute elements can include independent compute elements, clustered compute elements, etc. Execution of specific compute element operations can enable parallel operation processing. The parallel operation processing can include processing nodes of a graph that are independent of each other, processing independent tasks and subtasks, etc. The operations can include arithmetic, logic, array, matrix, tensor, and other operations. A given compute element can be enabled for operation execution, idled for a number of cycles when the compute element is not needed, etc. The operations that are executed can be repeated. An operation can be based on a plurality of control words.

The operations that are being executed can include data dependent operations. In embodiments, the plurality of control words includes two or more data dependent branch operations. The branch operation can include two or more branches, where a branch is selected based on an operation such as an arithmetic or logical operation. In a usage example, a branch operation can determine the outcome of an expression such as A>B. If A is greater than B, then one branch can be taken. If A is less than or equal to B, then another branch can be taken. In order to expedite execution of a branch operation, sides of the branch can be precomputed prior to datum A and datum B being available. When the data is available, the expression can be computed, and the proper branch direction can be chosen. The untaken branch data and operations can be discarded, flushed, etc. In embodiments, the two or more data dependent branch operations can require a balanced number of execution cycles. The balanced number of execution cycles can reduce or eliminate idle cycles, stalling, and the like. In embodiments, the balanced number of execution cycles is determined by the compiler. In embodiments, the generating, the customizing, and the executing can enable background memory access. The background memory access can enable a control element to access memory independently of other compute elements, a controller, etc. In embodiments, the background memory access can reduce load latency. Load latency is reduced since a compute element can access memory before the compute element exhausts the data that the compute element is processing.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

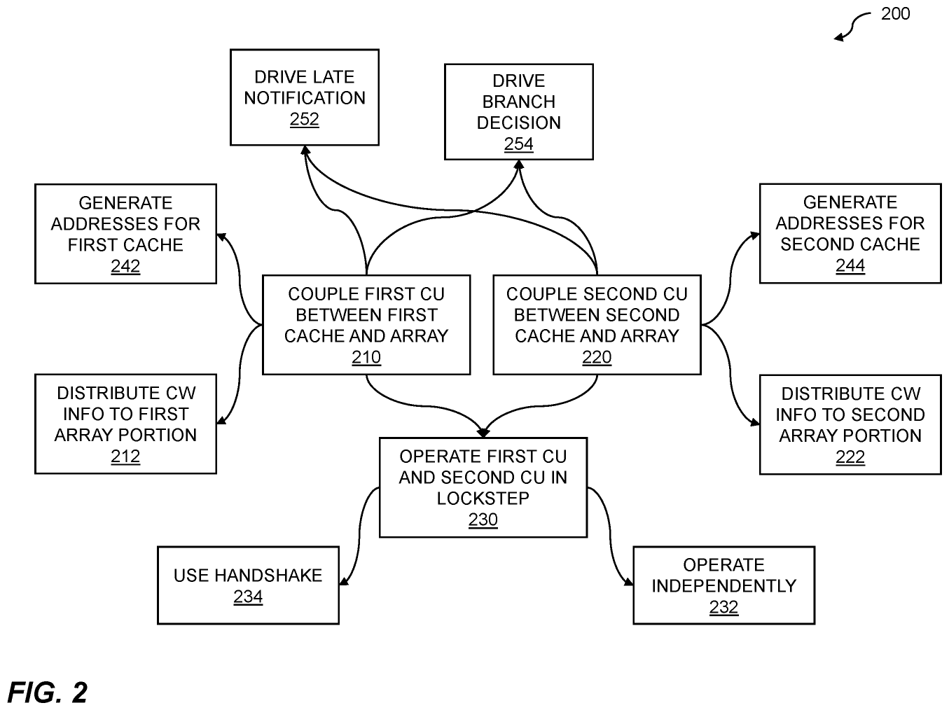

FIG. 2 is a flow diagram for control unit operation. Control words generated by a compiler are split between control word caches that are coupled to a 2D array of compute elements. The splitting of the control words provides for control of portions of the compute elements. The controlling portions enables parallel processing of tasks, subtasks, and so on. The parallel processing is accomplished by executing sets of compute element operations on the portions of the compute elements within a 2D array of compute elements. Compute elements can be grouped with the portions, where the groupings of compute elements can include pairs, quads, and so on. The sets of compute element operations can be associated with multiple, independent loops that include load operations and store operations. Collections, clusters, or groupings of compute elements (CEs), such as CEs assembled within a 2D array of CEs, can be configured to execute a variety of operations associated with programs, codes, apps, loops, and so on. The operations can be based on tasks, and on subtasks that are associated with the tasks. The 2D array can further interface with other elements such as controllers, storage elements, ALUs, MMUs, GPUs, multiplier elements, convolvers, and the like. The operations can accomplish a variety of processing objectives such as application processing, data manipulation, design and simulation, and so on. The operations can perform manipulations of a variety of data types including integer, real, floating point, and character data types; vectors and matrices; tensors; etc. A two-dimensional (2D) array of compute elements is accessed, wherein each compute element within the array of compute elements is known to a compiler and is coupled to its neighboring compute elements within the array of compute elements. A control word cache is coupled to the array of compute elements, wherein the first control word cache enables loading control words to a first portion of the array of compute elements. A second control word cache is coupled to the array of compute elements, wherein the second control word cache enables loading control words to a second portion of the array of compute elements. The control words are split between the first control word cache and the second control word cache, wherein the splitting is based on the constituency of the first portion of the array of compute elements and the second portion of the array of compute elements. Instructions are executed within the array of compute elements, wherein instructions executed within the first portion of the array of compute elements use control words loaded from the first control word cache, and wherein instructions executed within the second portion of the array of compute elements use control words loaded from the second control word cache.

Operations associated with the control words split between the control word caches can be stored in one or more associative memories. An associative memory can be included with each compute element. By using control words provided from the caches on a cycle-by-cycle basis, a controller configures array elements such as compute elements, and enables execution of a compiled program on the array. The compute elements can access registers, scratchpads, caches, and so on, that contain control words, data, etc. The compute elements can further be designated in a topological set of compute elements (CEs). The topological set of CEs can implement one or more topologies, where a topology can be mapped by the compiler. The topology mapped by the compiler can include a graph such as a directed graph (DG) or directed acyclic graph (DAG), a Petri Net (PN), etc. In embodiments, the compiler maps machine learning functionality to the array of compute elements. The machine learning can be based on supervised, unsupervised, and semi-supervised learning; deep learning (DL); and the like. In embodiments, the machine learning functionality can include a neural network implementation. The compute elements can be coupled to other elements within the array of CEs. In embodiments, the coupling of the compute elements can enable one or more topologies. The other elements to which the CEs can be coupled can include storage elements such as one or more levels of cache storage, multiplier units, address generator units for generating load (LD) and store (ST) addresses, queues, and so on. The compiler to which each compute element is known can include a C, C++, or Python compiler. The compiler to which each compute element is known can include a compiler written especially for the array of compute elements. The coupling of each CE to its neighboring CEs enables sharing of elements such as cache elements, multiplier elements, ALU elements, or control elements; communication between or among neighboring CEs; and the like.

The flow 200 includes coupling 210 a control unit between the first control word cache and the first portion of the array of compute elements. The control unit can comprise a first control unit. The first control unit can initiate execution by the compute elements in a first portion of the array of processes, tasks, subtasks, etc. The executing can include execution of loops, where loops can include executing a number of operations for a number of iterations. In the flow 200, the first control unit distributes 212 control word information to the first portion of the array of compute elements. The control word information can configure compute elements, enable or disable (idle) compute elements, allocate storage, enable access to arithmetic logic units (ALUs), etc. The flow 200 further includes coupling 220 a second control unit between the second control word cache and the second portion of the array of compute elements. The second control unit can initiate execution by the compute elements in a second portion of the array of processes, tasks, subtasks, etc. In the flow 200, the second control unit distributes 222 control word information to the second portion of the array of compute elements.

The compute elements within the 2D array of compute elements can be controlled by one or more control units. For a parallel processing architecture with split control word caches, the array of compute elements can be controlled by the control unit and the second control unit. Recall that the compiler controls the individual elements within the array of compute elements using one or more control words. The control words are further able to control other elements associated with the array of compute elements. The control unit and the second control unit can pause the array to ensure that new control words are not driven into the array before control words in the array can be executed. The control units can receive a decompressed control word from one or more control word decompressors. The control units can drive out decompressed control words into their constituent portions of the 2D compute element array. The decompressed control words can enable or idle rows or columns of compute elements, enable or idle individual compute elements, transmit control words to individual compute elements, etc.

Discussed above and throughout, portions of the 2D array of compute elements, such as the first portion and the second portion, can process data. The data processing can be accomplished by executing tasks, subtasks, and so on. The portions of the 2D array of compute elements can include individual compute elements; pairs, quads, or groupings of compute elements; regions of the 2D array; and so on. The portions of the 2D array can process tasks, subtasks, etc., to accomplish parallel processing. The parallel processing can include processing independent tasks in parallel, processing dependent tasks in a given order, and the like. In embodiments, the parallel processing can be based on a graph such as a directed acyclic graph (DAG), a Petri Net, and the like. The parallel processing can be accomplished using an artificial neural network (ANN). In the flow 200, the first control unit and the second control unit can operate in lockstep 230 on a cycle-by-cycle basis. The lockstep can include executing substantially similar tasks on multiple datasets. Such lockstep operation can accomplish single instruction multiple data (SIMD) processing. In the flow 200, the first control unit and the second control unit operate independently 232 from each other. Each control unit can provide operations associated with tasks and subtasks that can be executed independently of tasks and subtasks associated with the other control unit. The independently operating control units can exchange a handshake 234 signal(s) between themselves to ensure lockstep operation is maintained. Completion of a handshake using the handshake signal or signals can be required before completion of an architectural cycle and before each control unit drives a new split CCW into the array of compute elements.

The flow 200 includes generating addresses to access control word data for the first cache 242 and the second cache 244. In embodiments, the first control unit generates addresses for accessing the first control word cache and the second control unit generates addresses for accessing the second control word cache. Because the control units operate in lockstep but independently, any late data loads must cause a halt notification to be driven 252 to both the first control unit and the second control unit, and the notifications must occur at the same time so that both control units can take action to stop processing until the late data safely arrives in the compute element array. Alternatively, if a lockstep handshake is used, then late signals do not need to be driven to both control units. Similarly, when a programming branch is decided, the compute element array must drive the branch decision 254 to both control units. These actions enable coherency to be maintained. In embodiments, a late load notification signal is driven to both the first control unit and the second control unit at the same time. In embodiments, a branch decision signal from either the first portion of the array of compute elements or the second portion of the array of compute elements is driven to both the first control unit and the second control unit at the same time. In embodiments, the first control word cache and the second control word cache being the same size enables identical cache hit rates and cache misses. In these embodiments, the split CCWs are “padded” to be identical size so that the cache hierarchy behavior on each side is identical.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors.

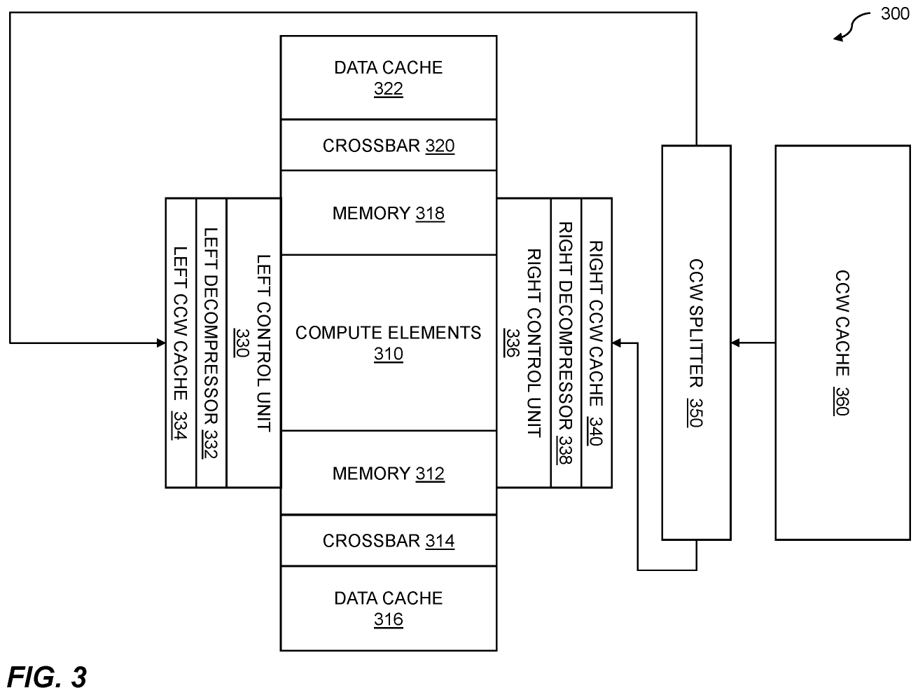

FIG. 3 is a system block diagram for compressed control word (CCW) splitting. Discussed above and throughout, control words associated with a parallel processing architecture can be split between control word caches. The control word caches can be coupled to an array of compute elements and can be used to control distinct portions of the array. The use of multiple control word caches expedites execution of tasks and subtasks on the array of compute elements by enabling substantially simultaneous, independent control of the portions of the array. The compressed control word splitting across control word caches enables a parallel processing architecture. A two-dimensional array of compute elements is accessed, wherein each compute element within the array of compute elements is known to a compiler and is coupled to its neighboring compute elements within the array of compute elements. A first control word cache is coupled to the array of compute elements, wherein the first control word cache enables loading control words to a first portion of the array of compute element. A second control word cache is coupled to the array of compute elements, wherein the second control word cache enables loading control words to a second portion of the array of compute elements. The control words are split between the first control word cache and the second control word cache, wherein the splitting is based on the constituency of the first portion of the array of compute elements and the second portion of the array of compute elements. Instructions are executed within the array of compute elements, wherein instructions executed within the first portion of the array of compute elements use control words loaded from the first control word cache, and wherein instructions executed within the second portion of the array of compute elements use control words loaded from the second control word cache.

FIG. 3 is a system block diagram for compressed control word (CCW) splitting. Control words that can be provided to control compute elements within a 2D array of compute elements can be split between a plurality of control word caches. The splitting of the control words can replace a single control word cache with two (or more) caches. In the case of two caches, the individual caches can be smaller than the single cache. The small caches can provide control words to portions of the 2D array of compute elements with reduced access delay, where the reduced access delay results from shorter communications channels associated with the smaller cache sizes. The system block diagram includes compute elements 310. The compute elements 310 can include processors, central processing units (CPUs), graphics processing units (GPUs), coprocessors, and the like. The compute elements can further be based on processing cores configured within integrated circuits or “chips” such as application specific integrated circuits (ASICs), processing cores programmed within programmable chips such as field programmable gate arrays (FPGAs), etc. The compute elements can comprise an array of substantially similar compute elements. The system block diagram 300 can include memory elements such as memory 312 and memory 318. The memory elements can include load buffers, where the load buffers can hold data for processing within the array of compute elements.

The system block diagram 300 can include one or more crossbar switches such as crossbars 314 and 320. The crossbar switches can be used to route data from data storage to the load buffers. The crossbar switches provide an efficient technique for routing data from storage such as on-array storage, shared storage, near-array storage, off-array storage, and so on, to compute elements that can be used to process the data. The system block diagram can include data caches such as data cache 316 and 322. The data caches can be coupled to access buffers (not shown), where the access buffers can be coupled between the data caches and the crossbars. The data caches can include one or more levels of cache, such as level-1 (L1) cache, level-2 (L2) cache, and the like. Additional levels of cache can be included in the block diagram 300. Further embodiments can include coupling a common level-3 (L3) cache to the data caches. The data cache such as data caches 316 and 322 can include a dual read, single write (2R1W) cache. That is, the 2R1W cache can enable two read operations and one write operation contemporaneously without the read and write operations interfering with one another.

The system block diagram 300 can include control units such as left control unit 330 and right control unit 336. The left control unit can enable control of a first portion of the array of compute elements, and the right control unit can enable control of a second portion of the array of compute elements. The left control unit and the right control unit can initiate execution by the compute elements of processes, tasks, subtasks, etc. The executing can include execution of loops, where loops can include executing a number of operations for a number of iterations. The system block diagram 300 can include decompressors such as left decompressor 332 and right decompressor 338. The decompressors can decompress compressed control words. The compressed control words can be generated by a compiler and can be transferred to storage (discussed below) associated with the 2D array of compute elements. The compressed control words can be shorter than uncompressed control words and can require less storage than their uncompressed counterparts. The system block diagram 300 can include compressed control word caches (CCW) such as left CCW cache 334 and right CCW cache 340. The caches can be located within the 2D array of compute elements, adjacent to the array, etc. The caches can be based on multiple layers of cache. In embodiments, the first or left control word cache and the second or right control word cache each can include a level-1/level-2 (L1/L2) cache bank. The cache bank can include the L1 and L2 caches, access buffers, etc.

The system block diagram 300 can include a compressed control word (CCW) splitter 350. The CCW splitter can be used to split the control words between the first or left control word cache 334 and the second or right control word cache 340. The splitting can be based on processing tasks and subtasks, compute element requirements for the tasks and subtasks, compute element availability for processing, and so on. In embodiments, the splitting is based on the constituency of the first portion of the array of compute elements and the second portion of the array of compute elements. The first portion of the array and the second portion of the array can be based on individual compute elements, pairs or quads of compute elements, groupings of compute elements, etc. The portions can be variable sizes and determined by the compiler for a particular job stream, or the portions can be fixed or semi-fixed by a hardware design point. The system block diagram 300 can include a compressed control word cache 360. The CCW cache 360 can include one or more levels of cache. The CCW cache can include a shared cache. The shared cache can store data, compressed control words, and the like. Further embodiments include coupling a common level-3 (L3) cache to the first (left) control word cache and the second (right) control word cache. The L3 can be located within the 2D array of compute elements, adjacent to the 2D array, etc.

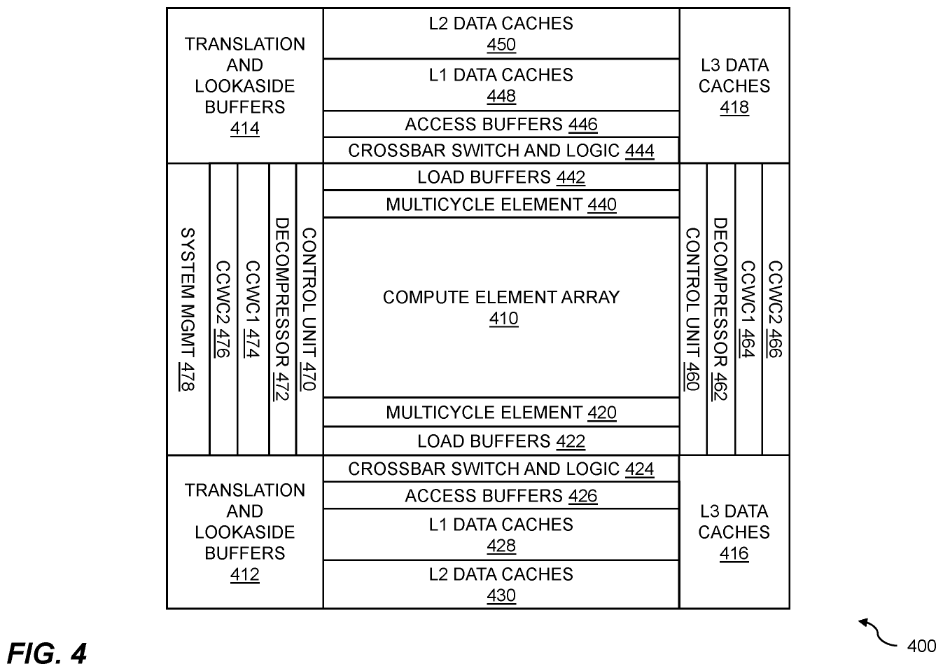

FIG. 4 is a system block diagram for a highly parallel architecture with a shallow pipeline. The highly parallel architecture can comprise components including compute elements, processing elements, buffers, one or more levels of cache storage, system management, arithmetic logic units, multipliers, memory management units, and so on. The various components can be used to accomplish parallel processing of tasks, subtasks, and so on. The task processing is associated with program execution, job processing, etc. The task processing is enabled based on a parallel processing architecture with split control word caches. A two-dimensional (2D) array of compute elements is accessed, wherein each compute element within the array of compute elements is known to a compiler and is coupled to its neighboring compute elements within the array of compute elements. A first control word cache is coupled to the array of compute elements, wherein the first control word cache enables loading control words to a first portion of the array of compute elements. A second control word cache is coupled to the array of compute elements, wherein the second control word cache enables loading control words to a second portion of the array of compute elements. The control words are split between the first control word cache and the second control word cache, wherein the splitting is based on the constituency of the first portion of the array of compute elements and the second portion of the array of compute elements. Instructions are executed within the array of compute elements, wherein instructions executed within the first portion of the array of compute elements use control words loaded from the first control word cache, and wherein instructions executed within the second portion of the array of compute elements use control words loaded from the second control word cache.

A system block diagram 400 for a highly parallel architecture with a shallow pipeline is shown. The system block diagram can include a compute element array 410. The compute element array 410 can be based on compute elements, where the compute elements can include processors, central processing units (CPUs), graphics processing units (GPUs), coprocessors, and so on. The compute elements can be based on processing cores configured within chips such as application specific integrated circuits (ASICs), processing cores programmed into programmable chips such as field programmable gate arrays (FPGAs), and so on. The compute elements can comprise a homogeneous array of compute elements. The system block diagram 400 can include translation and look-aside buffers such as translation and look-aside buffers 412 and 414. The translation and look-aside buffers can comprise memory caches, where the memory caches can be used to reduce storage access times.

The system block diagram 400 can include logic for load and store access order and selection. The logic for load and store access order and selection can include crossbar switch and logic 424 along with crossbar switch and logic 444. Crossbar switch and logic 424 can accomplish load and store access order and selection for the lower data cache blocks (428 and 430), and crossbar switch and logic 444 can accomplish load and store access order and selection for the upper data cache blocks (448 and 450). Crossbar switch and logic 424 enables high-speed data communication between the lower-half compute elements of compute element array 410 and data caches 428 and 430 using access buffers 426. Crossbar switch and logic 444 enables high-speed data communication between the upper-half compute elements of compute element array 410 and data caches 448 and 450 using access buffers 446. The access buffers 426 and 446 allow logic 424 and logic 444, respectively, to hold, load, or store data until any memory hazards are resolved. In addition, splitting the data cache between physically adjacent regions of the compute element array can enable the doubling of load access bandwidth, the reducing of interconnect complexity, and so on. While loads can be split, stores can be driven to both lower data caches 428 and 430 and upper data caches 448 and 450.

The system block diagram 400 can include lower load buffers 422 and upper load buffers 442. The load buffers can provide temporary storage for memory load data so that it is ready for low latency access by the compute element array 410. The system block diagram can include dual level 1 (L1) data caches, such as L1 data caches 428 and 448. The L1 data caches can be used to hold blocks of load and/or store data, such as data to be processed together, data to be processed sequentially, and so on. The L1 cache can include a small, fast memory that is quickly accessible by the compute elements and other components. The system block diagram can include level 2 (L2) data caches. The L2 caches can include L2 caches 430 and 450. The L2 caches can include larger, slower storage in comparison to the L1 caches. The L2 caches can store “next up” data, results such as intermediate results, and so on. The L1 and L2 caches can further be coupled to level 3 (L3) caches. The L3 caches can include L3 caches 416 and 418. The L3 caches can be larger than the L2 and L1 caches and can include slower storage. Accessing data from L3 caches is still faster than accessing main storage. In embodiments, the L1, L2, and L3 caches can include 4-way set associative caches.

The system block diagram 400 can include a lower multicycle element 420 and an upper multicycle element 440. The multicycle elements (MEMs) can provide efficient functionality for operations that span multiple cycles, such as multiplication operations, or even those of indeterminant cycle length, such as some division and square root operations. The MEMs can operate on data coming out of the compute element array and/or data moving into the compute element array. Multicycle element 420 can be coupled to the compute element array 410 and load buffers 422, and multicycle element 440 can be coupled to compute element array 410 and load buffers 442.

The system block diagram 400 can include a system management buffer 478. The system management buffer can be used to store system management codes or control words that can be used to control the array 410 of compute elements for system management operations. The system management buffer can be employed for holding opcodes, codes, routines, functions, etc. which can be used for exception or error handling, management of the parallel architecture for processing tasks, and so on. The system management buffer can be coupled to a decompressor 472. The decompressor can be used to decompress system management compressed control words (CCWs) from system management buffer 478. The compressed system management control words can require less storage than the uncompressed control words. The system management buffer 478 can also include a spill buffer. The spill buffer can comprise a large static random-access memory (SRAM) which can be used to support multiple nested levels of exceptions.

The compute elements within the array of compute elements can be controlled by one or more control units. For a parallel processing architecture with split control word caches, the array of compute elements can be controlled by at least two control units such as control 460 and control unit 470. While the compiler, through the control word, controls the individual elements within the array of compute elements and the elements associated with the array of compute elements, the control units 460 and 470 can pause the array to ensure that new control words are not driven into the array before control words in the array can be executed. The control unit 460 can receive a decompressed control word from a decompressor 462, and the control unit 470 can receive a decompressed control word from a decompressor 472. The control unit 460 can drive out a decompressed control word into constituent compute elements of compute element array 410. The constituent compute elements can comprise a first portion of the array of compute element. The control unit 470 can drive out a decompressed control word into constituent compute elements of compute element array 410. The constituent compute elements can comprise a second portion of the array of compute element. The decompressors can decompress control words (discussed below) to enable or idle rows or columns of compute elements, to enable or idle individual compute elements, to transmit control words to individual compute elements, etc. The constituent compute elements can comprise a left portion and a right portion of the compute element array, where the left portion is physically closer to control unit 470 and the right portion is physically closer to control unit 460. The compiler can determine the exact split of the left portion and the right portion before loading any control words. The compiler can determine whether the portions are equal in size or unequal in size.

The decompressors each can be coupled to compressed control word caches. Decompressor 462 can be coupled to a compressed control word store such as compressed control word cache 1 (CCWC1) 464. CCWC1 464 can include a cache such as an L1 cache that includes one or more compressed control words. CCWC1 464 can be coupled to a further compressed control word store such as compressed control word cache 2 (CCWC2) 466. CCWC2 can be used as an L2 cache for compressed control words. Decompressor 472 can be coupled to a compressed control word store such as compressed control word cache 1 (CCWC1) 474. CCWC1 474 can include a cache such as an L1 cache that includes one or more compressed control words. CCWC1 474 can be coupled to a further compressed control word store such as compressed control word cache 2 (CCWC2) 476. CCWC2 476 can be used as an L2 cache for compressed control words. CCWC2 466 and CCWC2 476 can be larger and slower than CCWC1 464 and CCWC1 474, respectively. In embodiments, the compressed control word caches CCWC1 464 and CCWC2 466, as well as the compressed control word caches CCWC1 474 and CCWC2 476, can include 4-way set associativity. In embodiments, the CCWC1 caches 464 and 474 can contain decompressed control words, in which case the caches could be designated as DCWC1. In this latter case, decompressor 462 can be coupled between CCWC1 464 (now DCWC1) and CCWC2 466. Similarly, decompressor 472 can be coupled between CCWC1 474 (now DCWC1) and CCWC2 476.

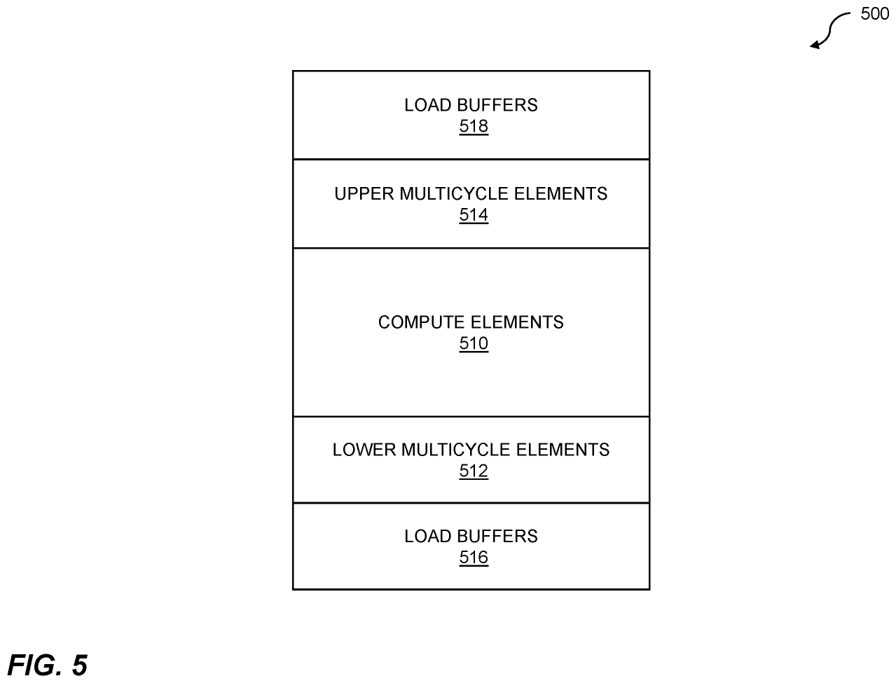

FIG. 5 shows compute element array detail. A compute element array can be coupled to components which enable the compute elements within the array to process one or more tasks, subtasks, and so on. A compute element further can be associated with a control word cache, into which control words for the array of compute elements have been split. The components can access and provide data, perform specific high-speed operations, and the like. The compute element array and its associated components 500 enable a parallel processing architecture with split control word caches. The compute element array 510 can perform a variety of processing tasks, where the processing tasks can include operations such as arithmetic, vector, or matrix operations; audio and video processing operations; neural network operations; etc. The compute elements can be coupled to multicycle elements such as lower multicycle elements 512 and upper multicycle elements 514. The multicycle elements can be used to perform, for example, high-speed multiplications associated with general processing tasks, multiplications associated with neural networks such as deep learning networks, multiplications associated with vector operations, and the like. The compute elements can be coupled to load queues such as load buffers 516 and load buffers 518. The load buffers, or load queues, can be coupled to the L1 data caches as discussed previously. The load queues can be used to load storage access requests from the compute elements. The load queues can track expected load latencies and can notify a control unit if a load latency exceeds a threshold. Notification of the control unit can be used to signal that a load may not arrive within an expected timeframe. The load queues can further be used to pause the array of compute elements. The load queues can send a pause request to the control unit that will pause the entire array, while individual elements can be idled under control of the control word. When an element is not explicitly controlled, it can be placed in the idle (or low power) state. No operation is performed, but ring buses can continue to operate in a “pass thru” mode to allow the rest of the array to operate properly. When a compute element is used just to route data unchanged through its ALU, it is still considered active.

While the array of compute elements is paused, background loading of the array from the memories (data and control word) can be performed. The memory systems can be free running and can continue to operate while the array is paused. Because multi-cycle latency can occur due to control signal transport, which results in additional “dead time”, it can be beneficial to allow the memory system to “reach into” the array and deliver load data to appropriate scratchpad memories while the array is paused. This mechanism can operate such that the array state is known, as far as the compiler is concerned. When array operation resumes after a pause, new load data will have arrived at a scratchpad, as required for the compiler to maintain the statically scheduled model.

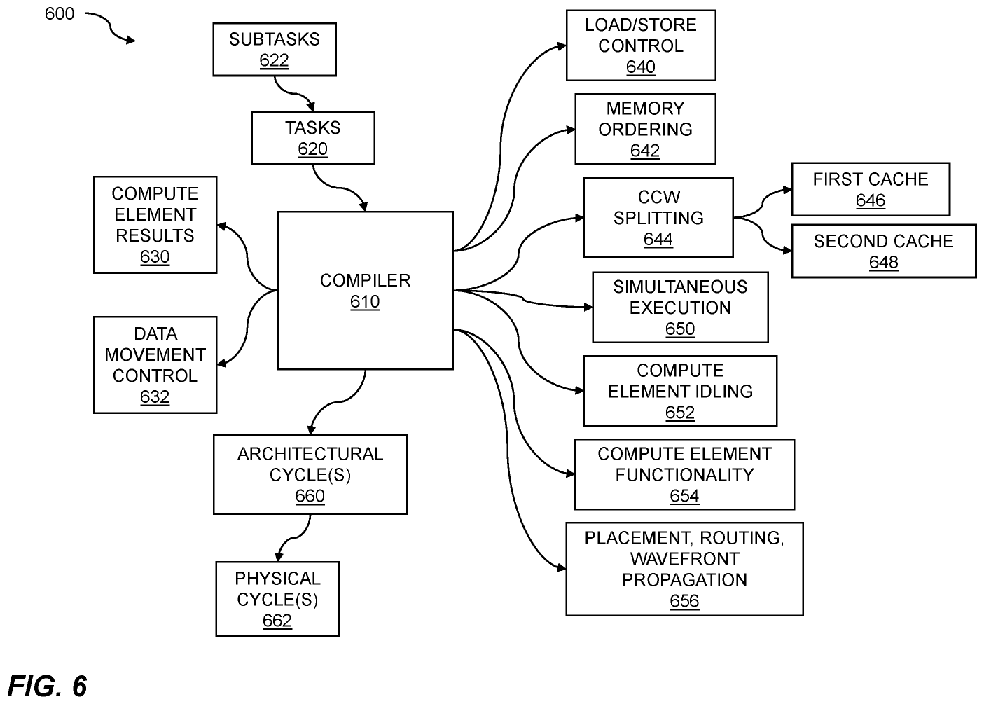

FIG. 6 illustrates a system block diagram for compiler interactions. Discussed throughout, compute elements within a 2D array are known to a compiler which can compile tasks and subtasks for execution on the array. The compiled tasks and subtasks are executed on one or more compute elements to accomplish parallel processing. A variety of interactions, such as configuration of compute elements, placement of tasks, routing of data, and so on, can be associated with the compiler. The compiler interactions enable a parallel processing architecture with split control word caches. A two-dimensional (2D) array of compute elements is accessed, wherein each compute element within the array of compute elements is known to a compiler and is coupled to its neighboring compute elements within the array of compute elements. A first control word cache is coupled to the array of compute elements, wherein the first control word cache enables loading control words to a first portion of the array of compute elements. A second control word cache is coupled to the array of compute elements, wherein the second control word cache enables loading control words to a second portion of the array of compute elements. The control words are split between the first control word cache and the second control word cache, wherein the splitting is based on the constituency of the first portion of the array of compute elements and the second portion of the array of compute elements. Instructions are executed within the array of compute elements, wherein instructions executed within the first portion of the array of compute elements use control words loaded from the first control word cache, and wherein instructions executed within the second portion of the array of compute elements use control words loaded from the second control word cache.

The system block diagram 600 includes a compiler 610. The compiler can include a high-level compiler such as a C, C++, Python, or similar compiler. The compiler can include a compiler implemented for a hardware description language such as a VHDL™ or Verilog™ compiler. The compiler can include a compiler for a portable, language-independent, intermediate representation such as low-level virtual machine (LLVM) intermediate representation (IR). The compiler can generate a set of directions that can be provided to the compute elements and other elements within the array. The compiler can be used to compile tasks 620. The tasks can include a plurality of tasks associated with a processing task. The tasks can further include a plurality of subtasks 622. The tasks can be based on an application such as a video processing or audio processing application. In embodiments, the tasks can be associated with machine learning functionality. The compiler can generate directions for handling compute element results 630. The compute element results can include results derived from arithmetic, vector, array, and matrix operations; Boolean operations; and so on. In embodiments, the compute element results are generated in parallel in the array of compute elements. Parallel results can be generated by compute elements when the compute elements can share input data, use independent data, and the like. The compiler can generate a set of directions that controls data movement 632 for the array of compute elements. The control of data movement can include movement of data to, from, and among compute elements within the array of compute elements. The control of data movement can include loading and storing data, such as temporary data storage, during data movement. In other embodiments, the data movement can include intra-array data movement. The loading and storing of data can be based on precedence. In embodiments, a precedence value can be derived by the hardware, based on the precedence information. The hardware can derive the precedence value based on compiler information. In embodiments, the precedence information can include a template value supplied by the compiler.

As with a general-purpose compiler used for generating tasks and subtasks for execution on one or more processors, the compiler can provide directions for task and subtasks handling, input data handling, intermediate and final result data handling, and so on. The compiler can further generate directions for configuring the compute elements, storage elements, control units, ALUs, and so on associated with the array. As previously discussed, the compiler generates directions for data handling to support the task handling. In the system block diagram, the data movement can include control of data loads and stores 640 with a memory array. The loads and stores can include handling various data types such as integer, real or float, double-precision, character, and other data types. The loads and stores can load and store data into local storage such as registers, register files, caches, and the like. The caches can include one or more levels of cache such as a level 1 (L1) cache, level 2 (L2) cache, level 3 (L3) cache, and so on. The loads and stores can also be associated with storage such as shared memory, distributed memory, etc. In addition to the loads and stores, the compiler can handle other memory and storage management operations including memory precedence. In the system block diagram, the memory access precedence can enable ordering of memory data 642. Memory data can be ordered based on task data requirements, subtask data requirements, task priority or precedence, and so on. The memory data ordering can enable parallel execution of tasks and subtasks.

The system block diagram 600 includes compressed control word (CCW) splitting 644. Control words can be split between control word caches, where each control word cache can be associated with a portion of a 2D array of compute elements. Embodiments include splitting the control words between the first control word cache 646 and the second control word cache 648. The splitting can be based on the constituency of the first portion of the array of compute elements and the second portion of the array of compute elements. A constituency of compute elements can include one or more compute elements within the array of compute elements. A constituency of compute elements can include a pair, a quad, a region, etc. of compute elements within the 2D array of compute elements. The system block diagram 600 includes enabling simultaneous execution 650 of two or more potential compiled task outcomes based on the set of directions. The code that is compiled by the compiler can include branch points, where the branch points can include computations or flow control. Flow control transfers program execution to a different sequence of control words. Since the result of a branch decision, for example, is not known a priori, the initial operations associated with both paths are encoded in the currently executing control word stream. When the correct result of the branch is determined, then the sequence of control words associated with the correct branch result continues execution, while the operations for the branch path not taken are halted and side effects may be flushed. In embodiments, the two or more potential branch paths can be executed on spatially separate compute elements within the array of compute elements. The simultaneous execution can include substantially simultaneous execution of multiple, independent loops. An independent loop can represent a portion of a subtask, a subtask, a portion of a task, a task, etc.

The system block diagram includes compute element idling 652. In embodiments, the set of directions from the compiler can idle an unneeded compute element within a row of compute elements located in the array of compute elements. Not all of the compute elements may be needed for processing, depending on the tasks, subtasks, and so on that are being processed. The compute elements may not be needed simply because there are fewer tasks to execute than there are compute elements available within the array. In embodiments, the idling can be controlled by a single bit in the control word generated by the compiler. In the system block diagram, compute elements within the array can be configured for various compute element functionalities 654. The compute element functionality can enable various types of computer architectures, processing configurations, and the like. In embodiments, the set of directions can enable machine learning functionality. The machine learning functionality can be trained to process various types of data such as image data, audio data, medical data, etc. In embodiments, the machine learning functionality can include neural network implementation. The neural network can include a convolutional neural network, a recurrent neural network, a deep learning network, and the like. The system block diagram can include compute element placement, results routing, and computation wave-front propagation 656 within the array of compute elements. The compiler can generate directions or instructions that can place tasks and subtasks on compute elements within the array. The placement can include placing tasks and subtasks based on data dependencies between or among the tasks or subtasks, placing tasks that avoid memory conflicts or communications conflicts, etc. The directions can also enable computation wave-front propagation. Computation wave-front propagation can implement and control how execution of tasks and subtasks proceeds through the array of compute elements.

In the system block diagram, the compiler can control architectural cycles 660. An architectural cycle can include an abstract cycle that is associated with the elements within the array of elements. The elements of the array can include compute elements, storage elements, control elements, ALUs, and so on. An architectural cycle can include an “abstract” cycle, where an abstract cycle can refer to a variety of architecture level operations such as a load cycle, an execute cycle, a write cycle, and so on. The architectural cycles can refer to macro-operations of the architecture rather than to low level operations. One or more architectural cycles are controlled by the compiler. Execution of an architectural cycle can be dependent on two or more conditions. In embodiments, an architectural cycle can occur when a control word is available to be pipelined into the array of compute elements and when all data dependencies are met. That is, the array of compute elements does not have to wait for either dependent data to load or for a full memory queue to clear. In the system block diagram, the architectural cycle can include one or more physical cycles 662. A physical cycle can refer to one or more cycles at the element level that are required to implement a load, an execute, a write, and so on. In embodiments, the set of directions can control the array of compute elements on a physical cycle-by-cycle basis. The physical cycles can be based on a clock such as a local, module, or system clock, or some other timing or synchronizing technique. In embodiments, the physical cycle-by-cycle basis can include an architectural cycle. The physical cycles can be based on an enable signal for each element of the array of elements, while the architectural cycle can be based on a global, architectural signal. In embodiments, the compiler can provide, via the control word, valid bits for each column of the array of compute elements, on the cycle-by-cycle basis. A valid bit can indicate that data is valid and ready for processing, that an address such as a jump address is valid, and the like. In embodiments, the valid bits can indicate that a valid memory load access is emerging from the array. The valid memory load access from the array can be used to access data within a memory or storage element. In other embodiments, the compiler can provide, via the control word, operand size information for each column of the array of compute elements. Various operand sizes can be used. In embodiments, the operand size can include bytes, half-words, words, and double-words.

Discussed above and throughout, the control word bits comprise a control word bunch. A control word bunch can include a subset of bits in a control word. In embodiments, the control word bunch can provide operational control of a particular compute element, a multiplier unit, and so on. Buffers, or “bunch buffers” can be placed at each control element. In embodiments, the bunch buffers can hold a number of bunches such as 16 bunches. Other numbers of bunches, such as 8, 32, or 64 bunches, and so on, can also be used. The output of a bunch buffer associated with a compute element, multiplier element, etc., can control the associated compute element or multiplier element. In embodiments, an iteration counter can be associated with each bunch buffer. The interaction counter can be used to control a number of times that the bits within the bunch buffer are cycled through. In further embodiments, a bunch buffer pointer can be associated with each bunch buffer. The bunch buffer counter can be used to indicate or “point to” the next bunch of control word bits to apply to the compute element or multiplier element. In embodiments, data paths associated with the bunch buffers can be balanced during a compile time associated with processing tasks, subtasks, and so on. The balancing the data paths can enable compute elements to operate without the risk of a single compute element being starved for data, which could result in stalling the two-dimensional array of compute elements as data is obtained for the compute element. Further, the balancing the data paths can enable an autonomous operation technique. In embodiments, the autonomous operation technique can include a dataflow technique.

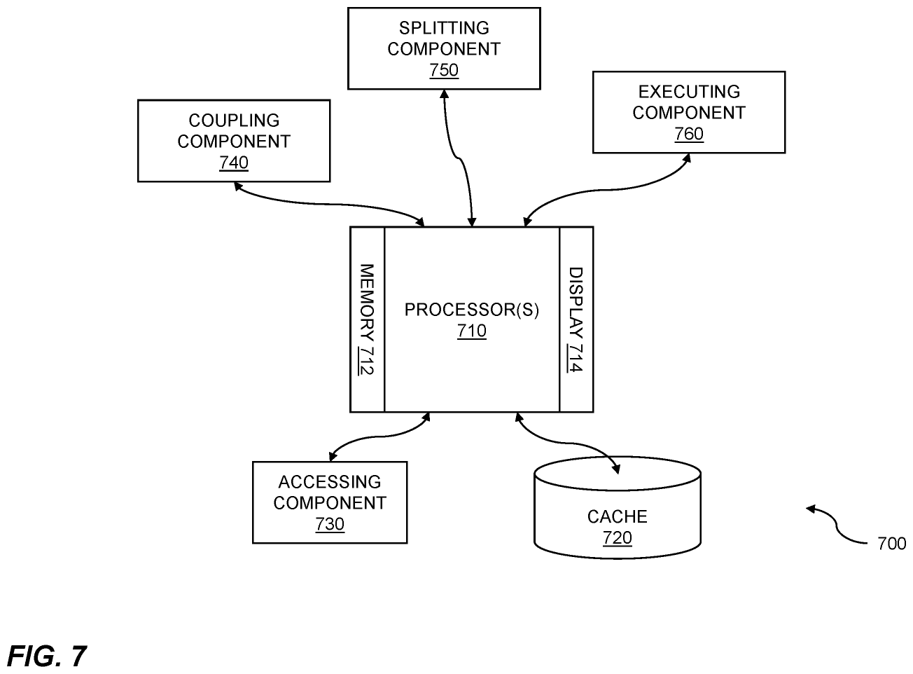

FIG. 7 is a system diagram for a parallel processing architecture with split control word caches. The parallel processing architecture with split control word caches is used to accomplish parallel processing, such as parallel processing of tasks, subtasks, and so on, within a 2D array of compute elements. The system 700 can include one or more processors 710, which are attached to a memory 712 which stores instructions. The system 700 can further include a display 714 coupled to the one or more processors 710 for displaying data; intermediate steps; directions; control words; precedence information; template values; control word splitting information; code preambles and epilogs; compressed control words; control words implementing Very Long Instruction Word (VLIW) functionality; topologies including systolic, vector, cyclic, spatial, streaming, or VLIW topologies; and so on. In embodiments, one or more processors 710 are coupled to the memory 712, wherein the one or more processors, when executing the instructions which are stored, are configured to: access a two-dimensional (2D) array of compute elements, wherein each compute element within the array of compute elements is known to a compiler and is coupled to its neighboring compute elements within the array of compute elements; couple a first control word cache to the array of compute elements, wherein the first control word cache enables loading control words to a first portion of the array of compute elements; couple a second control word cache to the array of compute elements, wherein the second control word cache enables loading control words to a second portion of the array of compute elements; split the control words between the first control word cache and the second control word cache, wherein the splitting is based on the constituency of the first portion of the array of compute elements and the second portion of the array of compute elements; and execute instructions within the array of compute elements, wherein instructions executed within the first portion of the array of compute elements use control words loaded from the first control word cache, and wherein instructions executed within the second portion of the array of compute elements use control words loaded from the second control word cache. The compute elements can include compute elements within one or more integrated circuits or chips, compute elements or cores configured within one or more programmable chips such as application specific integrated circuits (ASICs), field programmable gate arrays (FPGAs), heterogeneous processors configured as a mesh, standalone processors, etc.

The system 700 can include a cache 720. The cache 720 can be used to store data such as scratchpad data, operations that support a balanced number of execution cycles for a data-dependent branch, directions to compute elements, memory access operations tags, template values, precedence pointer data, intermediate results, microcode, branch decisions, and so on. The cache can comprise a small, local, easily accessible memory available to one or more compute elements. In embodiments, the data that is stored can include preloaded data that can enable splitting control words into a first control word cache and a second control word cache. The data within the cache can include data required to support dataflow processing by statically scheduled compute elements within the 2D array of compute elements. The cache can be accessed by one or more compute elements. The cache, if present, can include a dual read, single write (2R1W) cache. That is, the 2R1W cache can enable two read operations and one write operation contemporaneously without the read and write operations interfering with one another.

The system 700 can include an accessing component 730. The accessing component 730 can include control logic and functions for accessing a two-dimensional (2D) array of compute elements. Each compute element within the array of compute elements is known to a compiler and is coupled to its neighboring compute elements within the array of compute elements. A compute element can include one or more processors, processor cores, processor macros, processor cells, and so on. Each compute element can include an amount of local storage. The local storage may be accessible by one or more compute elements. Each compute element can communicate with neighbors, where the neighbors can include nearest neighbors or more remote “neighbors”. Communication between and among compute elements can be accomplished using a bus such as an industry standard bus, a ring bus, a network such as a wired or wireless computer network, etc. In embodiments, the ring bus is implemented as a distributed multiplexor (MUX). Compute elements with the 2D array of compute elements can be configured as a topologic set, where a topological set of compute elements can include a subset of compute elements within the 2D array of compute elements. The topological set of compute elements can include compute elements arranged to perform operations that enable systolic, vector, cyclic, spatial, and streaming processing, operations based on a VLIW instructions (e.g., command words), and the like.

The system 700 can include a coupling component 740. The coupling component 740 can include control and functions for coupling a first control word cache to the array of compute elements, wherein the first control word cache enables loading control words to a first portion of the array of compute elements. The first control word cache can be located within the 2D array of compute elements, adjacent to the array, and so on. The first control word cache can hold compressed control words, decompressed control words, and so on. In embodiments, the first control unit distributes control word information to the first portion of the array of compute elements. The first portion can include one or more compute elements. Embodiments include coupling a first control unit between the first control word cache and the first portion of the array of compute elements. The control unit can be used to control operation of one or more compute elements within the 2D array of compute elements. The coupling component 740 can further include control and functions for coupling a second control word cache to the array of compute elements, wherein the second control word cache enables loading control words to a second portion of the array of compute elements. The coupling of the second control word cache can be accomplished using the coupling component 740, a further coupling component, and so on. In embodiments, the second control unit distributes control word information to the second portion of the array of compute elements. The second portion of the array of compute elements can include one or more compute elements. In embodiments, the first control word cache and the second control word cache can each store compressed control words. The second control word cache can further hold decompressed control words. Embodiments further include coupling a second control unit between the second control word cache and the second portion of the array of compute elements. The second portion of the array of compute elements can include compute elements distinct from the first portion of compute elements.

The first control word cache and the second control word cache can be based on a variety of storage techniques. The storage techniques can be based on one or more register files, local storage such as a local random access read-write memory, and so on. In embodiments, the first control word cache and the second control word cache each can comprise a level-1/level-2 (L1/L2) cache bank. The L1/L2 cache banks can include local, fast storage that can be colocated with the compute elements within the 2D array of compute elements, located adjacent to the array, and the like. Further embodiments include coupling a common level-3 (L3) cache to the first control word cache and the second control word cache. The common L3 cache can store compressed control words and decompressed control words. In embodiments, the common L3 cache can store control words based on very long instruction words (VLIW).

The first control unit and the second control unit can be used to provide control for the compute elements on a cycle-by-cycle basis. The control can be enabled by a stream of wide control words generated by the compiler. The control words can be based on low-level control words such as assembly language words, microcode words, and so on. The control can include a control word bunches. In embodiments, the control word bunches can provide operational control of a particular compute element. The control of the array of compute elements on a cycle-by-cycle basis can include configuring the array to perform various compute operations. In embodiments, the stream of wide control words generated by the compiler provides direct, fine-grained control of the 2D array of compute elements. The compute operations can enable audio or video processing, artificial intelligence processing, machine learning, deep learning, and the like. The providing control can be based on microcode control words, where the microcode control words can include opcode fields, data fields, compute array configuration fields, etc. The compiler that generates the control can include a general-purpose compiler, a parallelizing compiler, a compiler optimized for the array of compute elements, a compiler specialized to perform one or more processing tasks, and so on. The providing control can implement one or more topologies such as processing topologies within the array of compute elements. In embodiments, the topologies implemented within the array of compute elements can include a systolic, a vector, a cyclic, a spatial, a streaming, or a Very Long Instruction Word (VLIW) topology. Other topologies can include a neural network topology. A control word can enable machine learning functionality for the neural network topology.

The system 700 can include a splitting component 750. The splitting component 750 can include control and functions splitting the control words between the first control word cache and the second control word cache, wherein the splitting is based on the constituency of the first portion of the array of compute elements and the second portion of the array of compute elements. The constituency of the first portion of the array of compute elements and the second portion of the array of compute elements can include individual compute elements, pairs or quads of compute elements, clusters of compute elements, quadrants of compute elements, etc. The constituency of the first and second portions of the array can be based on adjacency to the first control word cache or the second control word cache. The constituency of a portion can be based on minimizing communication delays between a control word cache and one or more compute elements.

Control word data, which can include one or more control words, can be used to provide control for the array of compute elements on a cycle-by-cycle basis. The control word data can be based on low-level control words such as assembly language words, microcode words, and so on. The control can be based on bits, where control word bits comprise a control word bunch. The control of the array of compute elements on a cycle-by-cycle basis can include configuring the array to perform various compute operations. In embodiments, a stream of wide control words generated by the compiler can provide direct, fine-grained control of the 2D array of compute elements. The compute operations can enable audio or video processing, artificial intelligence processing, machine learning, deep learning, and the like. The providing control can be based on microcode control words, where the microcode control words can include opcode fields, data fields, compute array configuration fields, etc. The compiler that generates the control can include a general-purpose compiler, a parallelizing compiler, a compiler optimized for the array of compute elements, a compiler specialized to perform one or more processing tasks, and so on. The providing control can implement one or more topologies such as processing topologies within the array of compute elements. In embodiments, the topologies implemented within the array of compute elements can include a systolic, a vector, a cyclic, a spatial, a streaming, or a Very Long Instruction Word (VLIW) topology. Other topologies can include a neural network topology. A control can enable machine learning functionality for the neural network topology.

The system block diagram 700 can include an executing component 760. The executing component 760 can include control and functions for executing instructions within the array of compute elements, wherein instructions executed within the first portion of the array of compute elements use control words loaded from the first control word cache, and wherein instructions executed within the second portion of the array of compute elements use control words loaded from the second control word cache. The control words that can be stored in the first control word cache and the second control word cache can include compressed control words, decompressed control words, VLIW, etc. The executing component can enable processing of a plurality of instances of substantially similar tasks and subtasks, where the plurality of instances can enable operations such as single instruction multiple data (SIMD) operations. The executing component can enable processing of substantially dissimilar tasks and subtasks. The executing can be controlled by the control units. In embodiments, the first control unit and the second control unit can operate in lockstep on a cycle-by-cycle basis. The lockstep basis can enable sharing of input data, exchange of control signals, and so on. The tasks and subtasks that are executed can be dependent on one another. In other embodiments, the first control unit and the second control unit operate independently from each other. The tasks and subtasks that are executed can be independent of one another. The executing can include execution of multiple, independent loops. The multiple, independent loops can be executed on one or more compute elements within the 2D array of compute elements.

The compute element operations that are executed can include task processing operations, subtask processing operations, and so on. The operations associated with tasks, subtasks, and so on can include arithmetic operations, Boolean operations, matrix operations, neural network operations, and the like. The operations can be executed based on the specific set of compute element operations associated with the multiple, independent loops. The specific set of compute element operations can be generated by the compiler. The control words can be provided to a control unit where the control unit can control the operations of the compute elements within the array of compute elements. Operation of the compute elements can include configuring the compute elements, providing data to the compute elements, routing and ordering results from the compute elements, and so on. In embodiments, the specific set of compute element operations associated with control words can be executed on a given cycle across the array of compute elements. The set of compute element operations can provide control to a set of compute elements on a per compute element basis, where each control word can be comprised of a plurality of compute element control groups, clusters, and so on.

The executing operations contained in one or more specific sets of compute element operations can include distributed execution of operations. In embodiments, the distributed execution of operations can occur in two or more compute elements within the array of compute elements. The executing operations can include storage access, where the storage can include a scratchpad memory, one or more caches, register files, etc. within the 2D array of compute elements. Further embodiments include a memory operation outside of the array of compute elements (discussed further below). The “outside” memory operation can include access to a memory such as a high-speed memory, a shared memory, remote memory, etc. In embodiments, the memory operation can be enabled by autonomous compute element operation. Data operations can be performed by a topological set of compute elements without loading further control words for a number of cycles. The autonomous compute element operation can be based on operation looping. In embodiments, the operation looping can accomplish dataflow processing within statically scheduled compute elements. Dataflow processing can include processing based on the presence or absence of data. The dataflow processing can be performed without requiring access to external storage. Discussed above and throughout, the executing can occur on an architectural cycle basis. An architectural basis can include a compute element cycle. In embodiments, the architectural cycle basis can reflect non-wall clock, compiler time.

The system 700 can include a computer program product embodied in a non-transitory computer readable medium for parallel processing, the computer program product comprising code which causes one or more processors to perform operations of: accessing a two-dimensional (2D) array of compute elements, wherein each compute element within the array of compute elements is known to a compiler and is coupled to its neighboring compute elements within the array of compute elements; coupling a first control word cache to the array of compute elements, wherein the first control word cache enables loading control words to a first portion of the array of compute elements; coupling a second control word cache to the array of compute elements, wherein the second control word cache enables loading control words to a second portion of the array of compute elements; splitting the control words between the first control word cache and the second control word cache, wherein the splitting is based on the constituency of the first portion of the array of compute elements and the second portion of the array of compute elements; and executing instructions within the array of compute elements, wherein instructions executed within the first portion of the array of compute elements use control words loaded from the first control word cache, and wherein instructions executed within the second portion of the array of compute elements use control words loaded from the second control word cache.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for parallel processing comprising:
accessing a two-dimensional array of compute elements, wherein each compute element within the array of compute elements is known to a compiler and is coupled to its neighboring compute elements within the array of compute elements;
coupling a first control word cache to the array of compute elements, wherein the first control word cache enables loading control words to a first portion of the array of compute elements;
coupling a second control word cache to the array of compute elements, wherein the second control word cache enables loading control words to a second portion of the array of compute elements;
splitting the control words between the first control word cache and the second control word cache, wherein the splitting is based on constituency of the first portion of the array of compute elements and the second portion of the array of compute elements; and
executing instructions within the array of compute elements, wherein instructions executed within the first portion of the array of compute elements use control words loaded from the first control word cache, and wherein instructions executed within the second portion of the array of compute elements use control words loaded from the second control word cache.

2. The method of claim 1 further comprising coupling a first control unit between the first control word cache and the first portion of the array of compute elements.

3. The method of claim 2 further comprising coupling a second control unit between the second control word cache and the second portion of the array of compute elements.

4. The method of claim 3 wherein the first control unit distributes control word information to the first portion of the array of compute elements.

5. The method of claim 4 wherein the second control unit distributes control word information to the second portion of the array of compute elements.

6. The method of claim 3 wherein the first control unit and the second control unit operate in lockstep on a cycle-by-cycle basis.

7. The method of claim 4 wherein the first control unit and the second control unit operate independently from each other.

8. The method of claim 3 wherein the first control unit generates addresses for accessing the first control word cache.

9. The method of claim 3 wherein the second control unit generates addresses for accessing the second control word cache.

10. The method of claim 3 wherein a late load notification signal is driven to both the first control unit and the second control unit at the same time.

11. The method of claim 3 wherein a branch decision signal from either the first portion of the array of compute elements or the second portion of the array of compute elements is driven to both the first control unit and the second control unit at the same time.

12. The method of claim 1 wherein the first control word cache and the second control word cache are the same size.

13. The method of claim 12 wherein the first control word cache and the second control word cache being the same size enables identical cache hit rates and cache misses.

14. The method of claim 1 wherein the first control word cache and the second control word cache each comprise a level-1/level-2 (L1/L2) cache bank.

15. The method of claim 14 further comprising coupling a common level-3 (L3) cache to the first control word cache and the second control word cache.

16. The method of claim 1 wherein the first control word cache and the second control word cache each store compressed control words.

17. The method of claim 16 wherein the compressed control words are decompressed before being consumed by a next unit.

18. The method of claim 1 wherein the array of compute elements is controlled on a cycle-by-cycle basis by a stream of wide control words generated by the compiler.

19. The method of claim 18 wherein the stream of wide control words comprises variable length control words generated by the compiler.

20. The method of claim 19 wherein the stream of wide, variable length, control words generated by the compiler provides direct, fine-grained control of the two-dimensional array of compute elements.

21. A computer program product embodied in a non-transitory computer readable medium for parallel processing, the computer program product comprising code which causes one or more processors to perform operations of:
accessing a two-dimensional array of compute elements, wherein each compute element within the array of compute elements is known to a compiler and is coupled to its neighboring compute elements within the array of compute elements;
coupling a first control word cache to the array of compute elements, wherein the first control word cache enables loading control words to a first portion of the array of compute elements;
coupling a second control word cache to the array of compute elements, wherein the second control word cache enables loading control words to a second portion of the array of compute elements;
splitting the control words between the first control word cache and the second control word cache, wherein the splitting is based on constituency of the first portion of the array of compute elements and the second portion of the array of compute elements; and
executing instructions within the array of compute elements, wherein instructions executed within the first portion of the array of compute elements use control words loaded from the first control word cache, and wherein instructions executed within the second portion of the array of compute elements use control words loaded from the second control word cache.

22. A computer system for parallel processing comprising:
a memory which stores instructions;
one or more processors coupled to the memory, wherein the one or more processors, when executing the instructions which are stored, are configured to:
access a two-dimensional array of compute elements, wherein each compute element within the array of compute elements is known to a compiler and is coupled to its neighboring compute elements within the array of compute elements;
couple a first control word cache to the array of compute elements, wherein the first control word cache enables loading control words to a first portion of the array of compute elements;
couple a second control word cache to the array of compute elements, wherein the second control word cache enables loading control words to a second portion of the array of compute elements;
split the control words between the first control word cache and the second control word cache, wherein the splitting is based on constituency of the first portion of the array of compute elements and the second portion of the array of compute elements; and
execute instructions within the array of compute elements, wherein instructions executed within the first portion of the array of compute elements use control words loaded from the first control word cache, and wherein instructions executed within the second portion of the array of compute elements use control words loaded from the second control word cache.
